(19) United States
(12) Patent Application Publication
(10) Pub. No.: US 2020/0300802 A1
(43) Pub. Date: Sep. 24, 2020

(54) METHANE SENSOR AND METHOD OF MAKING A METHANE SENSOR

(71) Applicant: Janak HANDA, Toronto (CA)

(72) Inventors: Michael POPE, Kitchener (CA); Manan DOSI, Waterloo (CA)

(21) Appl. No.: 16/357,817

(22) Filed: Mar. 19, 2019

(51) Int. Cl. G01N 27/407

(52) U.S. Cl. CPC G01N 27/4074; G01N 27/4075; G01N 27/4071

(57) ABSTRACT

A methane sensor and a method for making a methane sensor are provided. In another aspect, there is provided a methane sensor. The methane sensor includes a polymeric substrate including a plurality of electrodes including an anode and a cathode thereon. The plurality of electrodes are porous, conductive, carbon-bearing regions of the polymeric substrate containing pores. The methane sensor further includes a quantity of nanoparticles containing a selected catalyst in the pores of the plurality of electrodes. The methane sensor further includes a solid polymer electrolyte that is porous covering the plurality of electrodes.

### FIELD

The specification relates generally to methane sensing, and, in particular, to electrochemical methane sensing.

### BACKGROUND OF THE DISCLOSURE

Methane is a greenhouse gas that is more potent than carbon dioxide. A significant percentage of methane emissions occur through leakage of methane at joints in pipelines used to transport and distribute it. In addition, methane can leak at usage points such as in homes that consume natural gas for heating or cooking, and in workplaces that consume natural gas. Leakage of methane at such usage points has the additional risk of explosion in the event that the leaked methane encounters an ignition source. Additionally, certain industries such as the coal mining industry produce methane. The buildup of methane in coal mines can be toxic, and can also result in an explosion if ignited by an ignition source.

It is, therefore, of great benefit to detect the leakage of methane and to be able to quickly repair the leakage. However, the current state of the art renders it difficult to detect methane leakage. Some methane sensors of the prior art suffer from a number of deficiencies. For example, some methane sensors can only operate in a high temperature (e.g. >500 degrees C.) environment, making them unusable in a room-temperature environment. Optical sensors have been described, which employ absorption spectroscopy to detect the presence of methane gas. Such sensors have the advantage that they do not require high temperatures but they are too expensive to be deployed in large quantities along a large distribution network. Some proposed electrochemical sensors are subject to fouling, which would render them costly to maintain in operation.

There is, therefore a need for a methane sensor that is inexpensive to manufacture, inexpensive to operate, usable in temperature ranges that are seen by distribution networks, typical usage points and typical methane generation points.

### SUMMARY OF THE DISCLOSURE

In one aspect, there is provided a method for making a methane sensor, comprising:
a) providing a polymeric substrate;
b) applying a laser to the polymeric substrate to generate a plurality of porous, conductive carbon-bearing regions which include an anode and a cathode in the polymeric substrate;
c) applying a dispersion containing nanoparticles containing a selected catalyst to the anode and cathode to introduce the nanoparticles onto the anode and cathode, after step b);
d) drying the polymeric substrate to cause the nanoparticles to remain on the anode and the cathode; and
e) depositing a solid polymer electrolyte which is porous on the polymeric substrate to cover the anode and the cathode.

In another aspect, there is provided a methane sensor. The methane sensor includes a polymeric substrate including a plurality of electrodes including an anode and a cathode thereon. The plurality of electrodes are porous, conductive, carbon-bearing regions of the polymeric substrate containing pores. The methane sensor further includes a quantity of nanoparticles containing a selected catalyst in the pores of the plurality of electrodes. The methane sensor further includes a solid polymer electrolyte that is porous covering the plurality of electrodes.

### BRIEF DESCRIPTIONS OF THE DRAWINGS

For a better understanding of the various embodiments described herein and to show more clearly how they may be carried into effect, reference will now be made, by way of example only, to the accompanying drawings in which:

FIG. 1 is a plan view of a methane sensor in accordance with an embodiment of the present disclosure;

FIG. 2 is a perspective view of a variant of the methane sensor shown in FIG. 1,

FIG. 3 is a sectional elevation view of a variant of the methane sensor shown in FIG. 1, during operation;

FIG. 4 is a graph illustrating a relationship between a concentration of methane in the presence of the methane sensor shown in FIG. 1, and a current measured by the methane sensor;

FIG. 5 is a flowchart of a method of making a methane sensor in accordance with an embodiment of the present disclosure;

FIG. 6 is a sectional elevation view illustrating a step in the manufacture of the methane sensor shown in FIG. 3, in which a laser is used on a polymeric substrate to form electrodes thereon;

FIG. 7 is a perspective view illustrating another step in the manufacture of the methane sensor shown in FIG. 3, in which the polymeric substrate is immersed in a water-miscible, low-tension solvent;

FIG. 8 is a perspective view illustrating yet another step in the manufacture of the methane sensor shown in FIG. 3, in which the polymeric substrate is immersed in a dispersion of nanoparticles containing a catalyst;

FIG. 9 is a perspective view of a methane transmission piping system illustrating examples of sources and endpoints for the methane;

FIG. 10A is an SEM (scanning electron microsocope) image of a top view of some of the electrodes at a selected resolution, prior to application of a solid polymer electrolyte;

FIG. 10B is an SEM image of a top view of the electrodes shown in FIG. 10A, at a higher resolution than in FIG. 10A, prior to application of a solid polymer electrolyte;

FIG. 11A is an SEM image of a top view of the electrodes shown in FIG. 10A, at a selected resolution, after application of a solid polymer electrolyte;

FIG. 11B is an SEM image of a top view of the electrodes shown in FIG. 11A, at a higher resolution than in FIG. 11A, after application of a solid polymer electrolyte;

FIG. 12 is an SEM image of a sectional view of an electrode prior to application of the solid polymer electrolyte;

FIG. 13 is an SEM image of a sectional view of an electrode after application of the solid polymer electrolyte;

FIG. 14 is a magnified view of the inset region of the view of the electrode shown in FIG. 13;

FIG. 15 is a highly magnified view of the electrode shown in FIG. 13, showing the presence of nanoparticles containing the catalyst;

FIG. 16 is a graph that illustrates the current measured for a methane sensor in accordance with an embodiment of the present disclosure, using several test voltages, in an environment containing 50 ppm of methane and air; and

FIG. 17 is a graph that illustrates the current response of the methane sensor in different gas environments.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

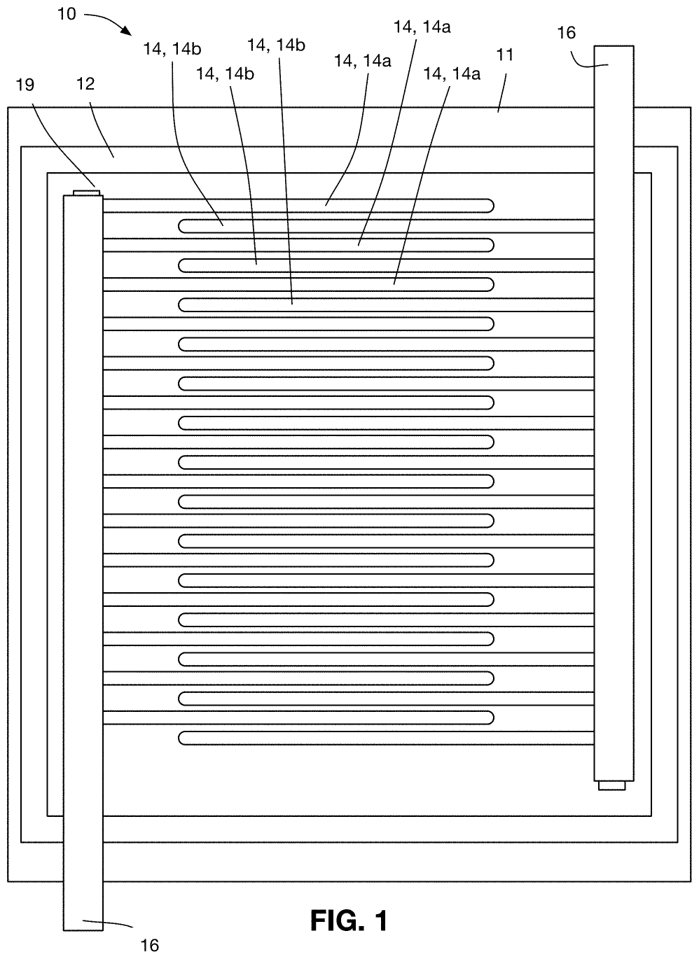

Reference is made to FIG. 1, which shows a methane sensor 10 in accordance with an embodiment of the present invention. The methane sensor 10 has, in some embodiments, many advantages over the prior art sensors used to detect the presence of methane. For example, the methane sensor 10, in some embodiments, is inexpensive to manufacture, can be operated using a low voltage, provides a strong relationship between its output signal and the concentration of methane it is exposed to. Furthermore, it liberates methane quickly, rather than getting fouled by it, and is capable of detecting very low concentrations of methane, such as a concentration of just a few ppm.

Referring to FIGS. 1, 2 and 3, the methane sensor 10 includes a polymeric substrate 12 which includes a plurality of electrodes 14 including, in the present example, an anode 14a, and a cathode 14b. It has been found that Kapton® is a suitable material for the polymeric substrate 12. It is believed that other materials may also be suitable as the polymeric substrate 12 including, but not limited to: polyfurfural alcohol, phenol-formaldehyde, lignin, cellulose, and graphene oxide.

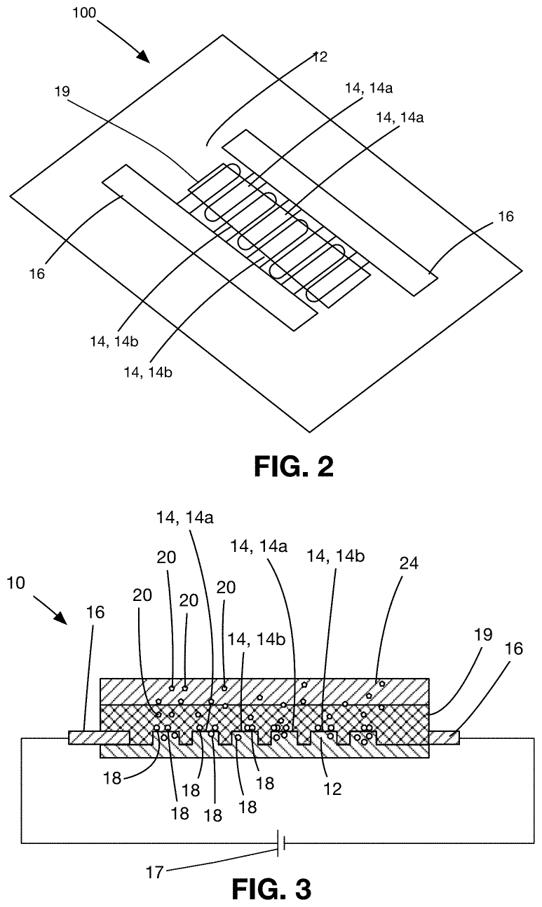

The electrodes 14 are preferably interdigitated as shown in FIG. 1. As can be seen in FIGS. 2 and 3 in particular, a conductor 16 may be applied to each electrode 14 to extend out from the methane sensor 10 so as to connect to a voltage source. A voltage source is shown schematically at 17 in FIG. 3. For greater clarity, FIG. 3 is a sectional view of the methane sensor 10, but is not shown to scale so as to facilitate understanding of the structure and operation of the methane sensor 10 by the reader of the present disclosure.

The methane sensor 10 further includes a quantity of nanoparticles 18 containing a selected catalyst, on the electrodes 14. In the embodiment shown in FIG. 1, the nanoparticles 18 are present on the electrodes 14 and not on the polymeric substrate 12 outside of the electrodes 14. The catalyst is a relatively expensive part of the methane sensor 10 and so it is advantageous to inhibit it from being present on the polymeric substrate 12 where it is non-functional.

The catalyst may be any suitable catalyst for the oxidation of methane. Examples include palladium, platinum, ruthenium, tungsten and some alloys thereof, as will be understood by one skilled in the art.

Furthermore, the methane sensor 10 includes a solid polymer electrolyte 19 that is porous, covering the plurality of electrodes 14. The solid polymer electrolyte 19 may be made from any suitable material. In an example the solid polymer electrolyte 19 may be formed by dissolving an ionic liquid in NMP (N-Methyl-2-pyrrolidone) or in DMF (dimethylformamide), combined with polyvinylidene fluoride. In another example, the ionic liquid may instead be dissolved in a solvent selected from the group consisting of: polymethylmethacrylate, polyethylene oxide, polyvinyl chloride and polyethylene glycol, combined with Nafion.

The ionic liquid may include a component selected from the group consisting of 1-ethyl-3-methylimidazolium tetrafluoroborate, 1-ethyl-3-methylimidazolium bis(trifluoromethylsulfonyl)imide, and another bis(trifluoromethylsulfonyl)imide.

The solid polymer electrolyte 19 may then be applied onto the polymeric substrate 12 in order to cover the electrodes 14. The solid polymer electrolyte 18 may alternatively include any other suitable room-temperature ionic liquid. Ionic liquids are advantageous in that they are non-volatile, as opposed to aqueous solutions. The use of a polymer electrolyte aids in the packaging of the ionic liquid in the sensor 10, and inhibits contamination of the ionic liquid from contact with the atmosphere.

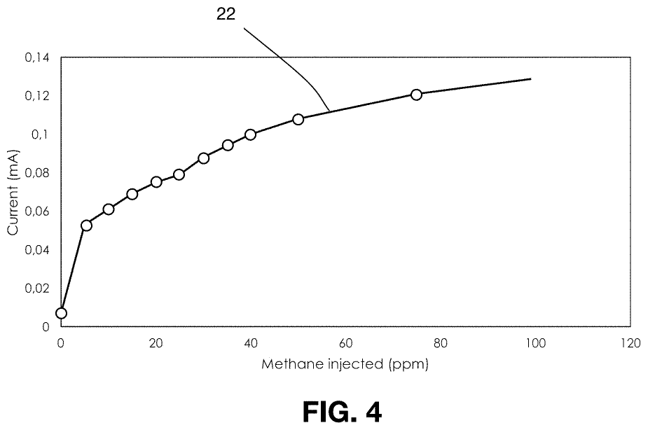

In FIG. 3, the operation of the methane sensor 10 is illustrated. A small voltage is maintained across the electrodes 14. Methane gas (shown at 20) can enter the methane sensor 10 through the pores of the solid polymer electrolyte 19. The methane gas 20 reaches the nanoparticles 18 of catalyst and the electrodes 14, and is oxidized. A current across the electrodes 14 can be measured. It has been found that the current that is measured varies with the concentration of methane 20 in the air around the methane sensor 10. FIG. 4 shows a graph with a curve 22 that shows an example relationship between the measured current and the concentration of methane 20. Using this relationship, by measuring the current across the electrodes 14, it is possible to determine the concentration of methane 20, and therefore it is possible to estimate the severity of a leak at a joint in methane piping system. As can be seen in the graph, at a methane concentration of 5 ppm, a current of more than 0.05 mA was measured. At a methane concentration of about 75 ppm, a current of about 0.12 mA was measured. In another embodiment, a sensitivity of 1.1 μA/ppm of methane was found, for a device having an area of about 2 cm². This is 4 orders of magnitude greater than some previously proposed methane sensors. A detection limit of about 9 ppm was determined.

Optionally, some means for inhibiting other gases from reaching the electrodes 14 may be provided in order to reduce the risk that the methane sensor 10 measures a current that is not associated with the presence of methane. For example, a membrane shown at 24 may be provided that permits methane to pass therethrough but inhibits organic molecules, such as ethane, that are larger than methane to pass therethrough.

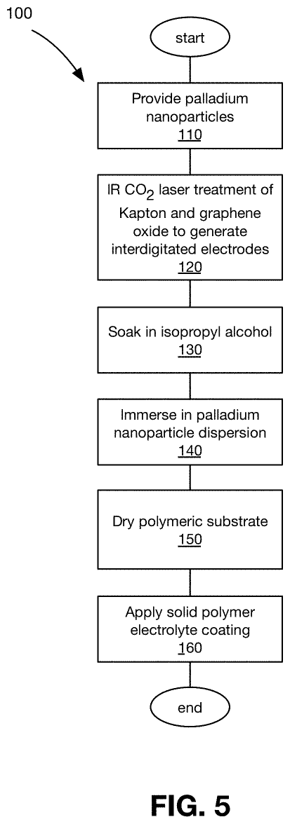

The manufacture of the methane sensor 10 may be carried out in any suitable way. An example method of manufacturing the methane sensor 10 is shown at 100 in FIG. 5. At step 110, a quantity of nanoparticles 18 of catalyst are provided. These may be provided in any suitable way, and may be provided in a dispersion, containing a suitable concentration of the catalyst. Tests were carried out at several different concentrations of a palladium catalyst at 20 or 25 mM concentration and with a hydrodynamic diameter of about 50 nm. It was found that the methane sensor 10 had an acceptable sensitivity to the concentration of methane in its presence. The sensitivity of the methane sensor 10 in this context refers to both the range of currents measured in relation to the concentration of methane in the presence of the methane sensor 10, and the lowest concentration of methane that can produce a measurable current. The graph shown in FIG. 4 was generated using a concentration of 20 mM of palladium catalyst.

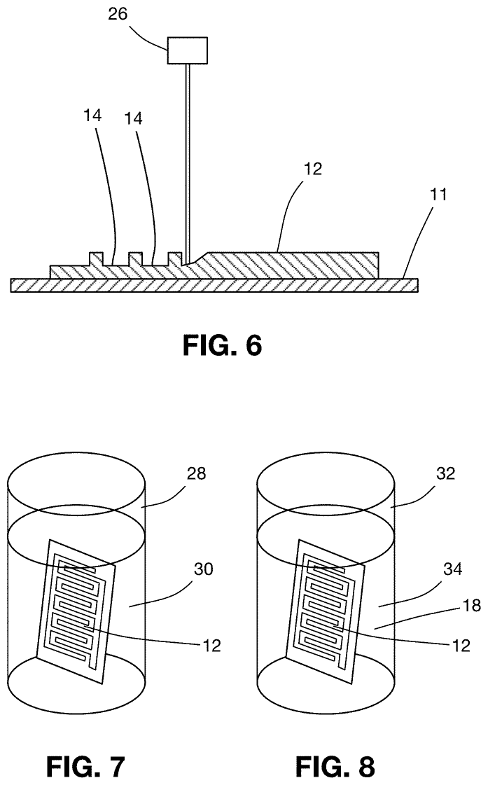

At step 120, the electrodes 14 are formed on the polymeric substrate 12. In the example shown in FIG. 6, a laser 26 may be used to ablate the polymeric substrate 12 along a selected path so as to form porous, conductive, carbon-bearing regions (optionally, specifically laser induced graphene-bearing regions) that are the electrodes 14. The laser 26 that is used may be an infrared CO₂ laser, which is a relatively inexpensive type of laser. A different type of laser may alternatively be used for this step, such as, for example: a helium neon laser, an argon ion laser, a noble gas ion laser, an Nd:YAG laser, an excimer laser, and a semiconductor diode laser.

It will be noted that, when the laser 26 applies a beam to the polymeric substrate 12, the rapid decomposition of the polymeric substrate 12 into gaseous products causes the material of the polymeric substrate 12 to expand while carbonizing. As a result of this expansion, the electrodes 14 extend higher than the surface of uncarbonized surface of the polymeric substrate 12 (i.e. than the surface of the polymeric substrate 12 that was not exposed to the laser 26). In some experiments the electrodes 14 extended higher than the uncarbonized surface of the polymeric substrate 12 by about 100 μm.

At step 130, a water-miscible solvent is applied to the polymeric substrate 12. For example, the polymeric substrate 12 may be immersed in a vessel 28 containing a volume of the water-miscible solvent 30, shown in FIG. 7. The water-miscible solvent 30 wets the electrodes 14 and does not remain on the rest of the polymeric substrate 12. A preferred water-miscible solvent that has been used, is isopropyl alcohol, however it is contemplated that acetone, ethanol, methanol, propanol and tetrahydrofuran may also be used.

The polymeric substrate 12 is then removed from the vessel 28 of water-miscible solvent 30, and then a dispersion of nanoparticles 18 of catalyst is applied to the polymeric substrate 12 at step 140. For example, the polymeric substrate 12 may be immersed in a vessel 32 containing an aqueous dispersion 34 of nanoparticles 18, shown in FIG. 8. The dispersion 34 is shown as being transparent so as to clearly show the polymeric substrate 12 immersed therein, however it is expected that it would be a dark liquid dispersion in actuality. It is here that a solvent exchange takes place whereby the nanoparticles move to the isopropyl alcohol on the electrodes 14. The polymeric substrate 12 is then removed from the dispersion 34 and dried at step 150, leaving the nanoparticles 18 of catalyst on the electrodes 14, and in particular, in the pores that are present on the electrodes 14. The pores are shown in FIG. 14 at 27. Some amount of the dispersion and therefore the nanoparticles 18 may remain on the surface of the polymeric substrate 12 outside of the electrodes 14, however it is expected that this amount will be relatively small since the surface of the polymeric substrate 12 is smooth. Examples of the catalyst include: palladium, platinum, rhodium, iridium. It is further contemplated that a combination of cobalt, nickel, phosphorous, a carbon nitride and a metal chalcogenide may also work.

Steps 130 and 140 are carried out, because carbon is hydrophobic, and so directly immersing the polymeric substrate 12 in the aqueous dispersion 34 without first wetting it with the isopropyl alcohol would not result in a useful amount of the catalyst remaining on the electrodes 14 upon removal of the polymeric substrate from the dispersion 34. However, in some embodiments, instead of using a dispersion 34 of nanoparticles 18 that is aqueous, the dispersion 34 may be a non-aqueous dispersion, which is in a suitable low-tension liquid. In such a case, carrying out a solvent exchange is not necessary and therefore, step 130 may be omitted. In other words, in such a case, step 140 may be carried out without first carrying out step 130. The choice of low-tension solvent for the dispersion may be selected based on the pore size of the electrodes 14 and optionally on additional properties of the methane sensor 10.

At step 160, the solid polymer electrolyte 19 is applied to the polymeric substrate 12 as shown in FIG. 3. If needed, prior to applying the solid polymer electrolyte 19, the conductors 16 may be mounted on the electrodes 14 so as to permit the methane sensor 10 to be connected to a voltage source (e.g. as shown at 17 in FIG. 3).

The application of the solid polymer electrolyte 19 may be carried out using any suitable method. For example, step 160 may involve providing the solid polymer electrolyte in a flowable form, and then at least one step selected from the group of steps consisting of:

ink-jet printing of the flowable form onto the anode and cathode, gravure printing of the flowable form onto the anode and cathode, screen printing of the flowable form onto the anode and cathode, spray deposition of the flowable form onto the anode and cathode, and casting the flowable form onto the anode and cathode.

Optionally, a membrane (e.g. as shown at 21 in FIG. 3) or some other means for inhibiting the ingress into the methane sensor 10 of undesired gases is applied on the outer surface of the solid polymer electrolyte 19 after the solid polymer electrolyte 19 is applied to the polymeric substrate 12.

It will be noted that the steps shown in FIG. 5 do not all need to be performed in the order shown. For example, step 110 could be provided between steps 130 and 140. However, some steps are contemplated to be performed after other steps. For example, step 130 (applying a water-miscible, low-tension solvent to wet the electrodes 14) is contemplated to be performed after step 120 (in which the electrodes 14 are formed). Step 140 (applying the dispersion of nanoparticles) is contemplated to be performed after step 130. Step 150 (drying the polymeric substrate) is contemplated to be performed after step 140, and step 160 (applying the solid polymer electrolyte) is contemplated to be performed after step 150.

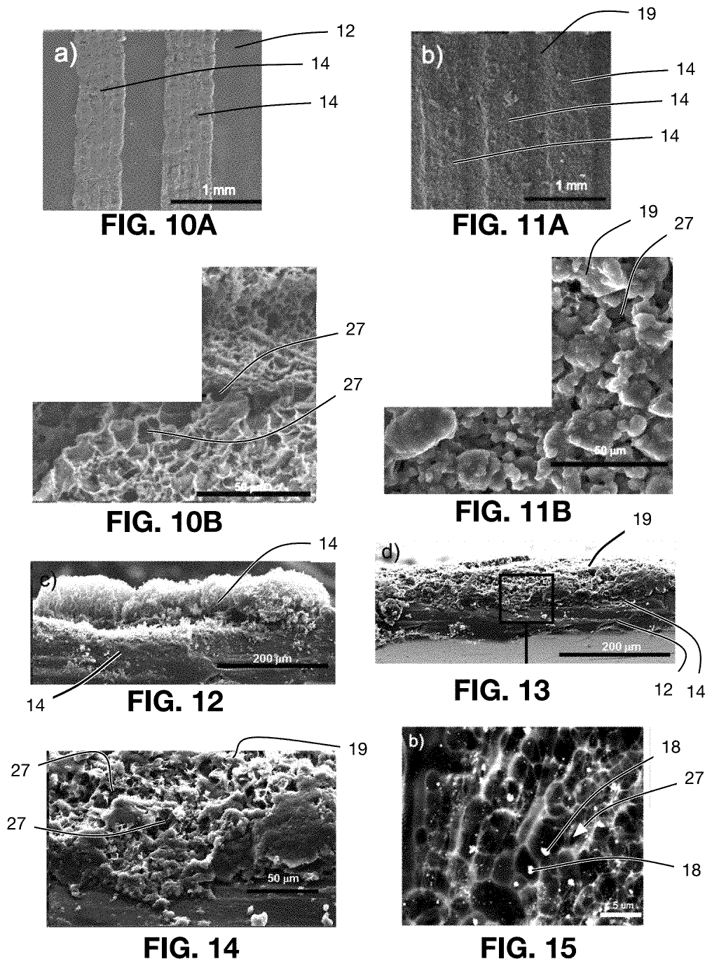

FIG. 10A is an SEM image of a top view of the electrodes 14 at a selected resolution, with FIG. 10B showing a higher resolution to highlight the porosity of the electrodes 14, prior to application of the solid polymer electrolyte 19. FIG. 11A is an SEM (scanning electron microscope) image of a top view of the electrodes 14 at a selected resolution, with FIG. 11B showing a higher resolution to highlight the porosity of the electrodes 14, after application of the solid polymer electrolyte 19. FIGS. 11A and 11B show that the electrodes 14 are uniformly covered by the solid polymer electrolyte 19. The solid polymer electrolyte 19 was observed to form a porous, globular-like structure on top of the entirety of the surface of the polymeric substrate 12, with an effective pore size of 5-20 μm, which permits the pass-through of methane more easily than a liquid film would.

FIG. 12 is an SEM image of a sectional view of an electrode 14 prior to application of the solid polymer electrolyte 19. FIG. 13 is an SEM image of a sectional view of an electrode 14 after application of the solid polymer electrolyte 19, while FIG. 14 is a magnified view of the inset region of the view of the electrode 14 in FIG. 13. As can be seen, the method described herein results in the solid polymer electrolyte 19 being imbibed into the porous electrode material so as to provide ionic contact to the catalyst nanoparticles 18. In other words, the nanoparticles 18 of catalyst are present in the pores of the electrodes 14. A highly magnified SEM image showing the nanoparticles 18 is shown in FIG. 15. It will be noted that the pores 27 themselves are not shown as clearly as they are in some of the other images, such as the images shown in FIGS. 10B, 11B and 14.

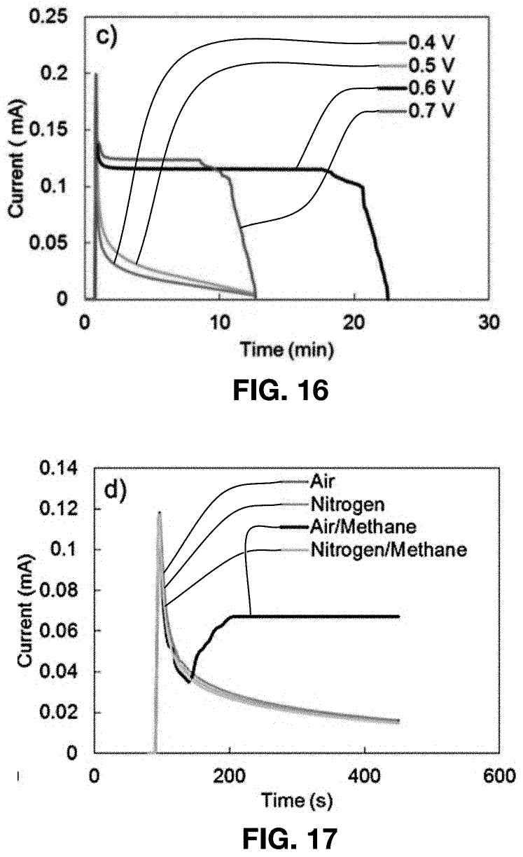

Experiments were carried out to assess the response of the methane sensor 10 under different conditions. FIG. 16 is a graph that illustrates the current measured for several test voltages, in an environment containing 50 ppm of methane and air. As can be seen, for a voltage of 0.4 V and 0.5 V only a spike in current, which exponentially decays to zero is observed. This is theorized to result from capacitive charging, resulting from the high surface area of the electrodes 14 in contact with the solid polymer electrolyte 19. At 0.6 V, a stable current of more than 0.1 mA is observed for over 15 minutes, which later decays to zero. At 0.7 V, a slightly higher current is observed for about 7 minutes, which then decays rapidly to zero.

FIG. 17 is a graph that illustrates the current response of the methane sensor 10 in different gas environments. As can be seen, the response of the methane sensor 10 is consistent in an air environment (with no methane), a nitrogen environment (with no methane), and a nitrogen/methane environment. However, in an environment containing air and methane, the response of the methane sensor 10 is different, which is indicative that the presence of oxygen is needed for the methane sensor 10 to operate.

It is theorized that the sensor carries out electro-oxidation of methane according to the following equation:

CH₄+2O₂→CO₂+2H₂O

Observations of the methane sensor 10 during operation indicated that water was present on the methane sensor 10 after methane was detected by the sensor 10. It was observed that, after sufficient time for the sensor 10 to dry, the performance of the methane sensor 10 was similar to its initial performance.

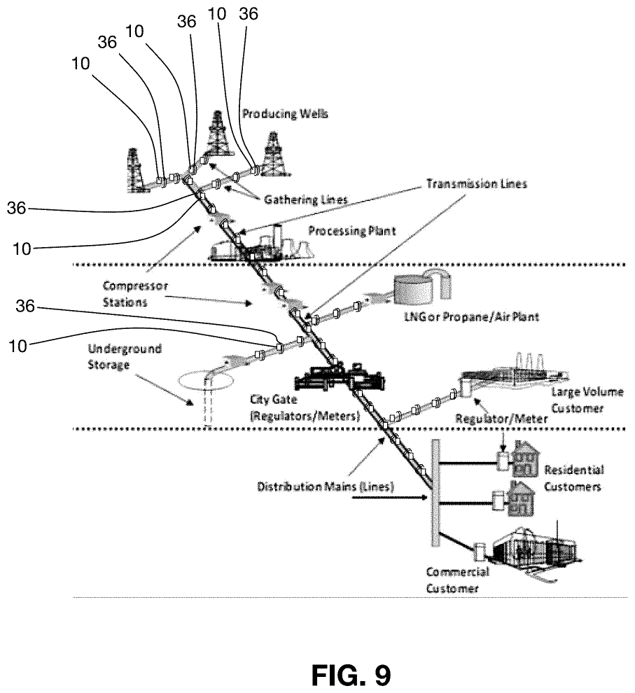

In use, the methane sensor 10 may be connected to a controller that has transmission capability, (e.g. via BlueTooth, Wi-Fi, Zigbee, or any other wireless protocol) or via a wired connection to a remote computer. What is transmitted may be the values of detected methane, and/or any alarm conditions indicating that the concentration of detected methane is above a threshold level, indicating a leak. In applications where the methane sensor 10 is one of many that are installed at joints 36 on a methane transmission piping system (as shown in FIG. 9) or at other suitable locations which are relatively remote, it is possible that a drone could be flown along the piping system so as to pick up signals from the methane sensors 10 that are installed thereon. It will be noted that the image shown in FIG. 9 is not to scale, and that only a small fraction of the number of joints are illustrated and accordingly only a small number of the methane sensors 10 are illustrated.

When used to detect leakage of methane at a joint 36 in a piping system it is preferable to mount the methane sensor at or above the top of the joint 36. This is because any methane leaking from the joint 36 will likely rise as it disperses since methane is lighter than air.

While the present disclosure describes a methane sensor, it is possible for the structure and method described herein to be applied to sensors for other gases. For example, the methane sensor 10, if connected to a voltage source that applied a higher voltage, such as, for example, about 0.8 V, could be used as an ethane sensor. It is possible that the certain things may be adjusted in order to improve the performance of the sensor 10 as an ethane sensor, such as the concentration of the catalyst in the dispersion.

Persons skilled in the art will appreciate that there are yet more alternative implementations and modifications possible, and that the above examples are only illustrations of one or more implementations. The scope, therefore, is only to be limited by the claims appended hereto.

What is claimed is:

1. A method for making a methane sensor, comprising:
a) providing a polymeric substrate;
b) applying a laser to the polymeric substrate to generate a plurality of porous, conductive carbon-bearing regions which include an anode and a cathode in the polymeric substrate;
c) applying a dispersion containing nanoparticles containing a selected catalyst to the anode and cathode to introduce the nanoparticles onto the anode and cathode, after step b);
d) drying the polymeric substrate to cause the nanoparticles to remain on the anode and the cathode; and
e) depositing a solid polymer electrolyte which is porous on the polymeric substrate to cover the anode and the cathode.

2. A method for making a methane sensor as claimed in claim 1, wherein the laser is selected from the group consisting of a helium neon laser, an argon ion laser, a noble gas ion laser, an Nd:YAG laser, an excimer laser, a CO₂ laser and a semiconductor diode laser.

3. A method for making a methane sensor as claimed in claim 1, wherein the polymeric substrate is selected from the group consisting of Kapton®, polyfurfural alcohol, phenol-formaldahyde, lignin, cellulose, and graphene oxide.

4. A method for making a methane sensor as claimed in claim 1, wherein the anode and the cathode are interdigitated with one another.

5. A method for making a methane sensor as claimed in claim 1, wherein the solid polymer electrolyte includes:
an ionic liquid dissolved in one of N-Methyl-2-pyrrolidone and dimethylformamide combined with polyvinylidene fluoride, or an ionic liquid dissolved in a solvent selected from the group consisting of:
polymethylmethacrylate, polyethylene oxide, polyvinyl chloride and polyethylene glycol combined with Nafion.

6. A method for making a methane sensor as claimed in claim 5, wherein the ionic liquid includes a component selected from the group consisting of 1-ethyl-3-methylimidazolium tetrafluoroborate, 1-ethyl-3-methylimidazolium bis(trifluoromethylsulfonyl)imide, and another bis(trifluoromethylsulfonyl)imide.

7. A method for making a methane sensor as claimed in claim 1, wherein step e) includes:
f) providing the solid polymer electrolyte in a flowable form, and
g) at least one step selected from the group of steps consisting of:
ink-jet printing of the flowable form onto the anode and cathode, gravure printing of the flowable form onto the anode and cathode, screen printing of the flowable form onto the anode and cathode, spray deposition of the flowable form onto the anode and cathode, and casting the flowable form onto the anode and cathode.

8. A method for making a methane sensor as claimed in claim 1, wherein the selected catalyst is selected from the group consisting of palladium, platinum, rhodium, iridium, or a combination of cobalt, nickel, phosphorous, a carbon nitride and a metal chalcogenide.

9. A method for making a methane sensor as claimed in claim 1, further comprising applying a membrane on an outside surface of the solid polymer electrolyte, wherein the membrane permits methane to pass therethrough but inhibits organic molecules that are larger than methane to pass therethrough.

10. A method for making a methane sensor as claimed in claim 1, wherein step c) includes:
h) applying a water-miscible solvent to the polymeric substrate after step b) to displace air from pores in the porous, conductive, carbon-bearing regions; and wherein applying the dispersion containing the nanoparticles containing the selected catalyst to the anode and cathode is carried out after step h);

11. A method for making a methane sensor as claimed in claim 10, wherein the water-miscible solvent is selected from the group consisting of isopropyl alcohol, acetone, ethanol, methanol, propanol and tetrahydrofuran.

12. A method for making a methane sensor as claimed in claim 1, wherein the dispersion is a non-aqueous dispersion and wherein applying the dispersion containing the nanoparticles containing the selected catalyst to the anode and cathode is carried out without first applying a water-miscible solvent to the polymeric substrate to displace air from pores of the porous, conductive, carbon-bearing regions.

13. A methane sensor comprising:
a polymeric substrate including a plurality of electrodes including an anode and a cathode thereon, wherein the plurality of electrodes are porous, conductive, carbon-bearing regions of the polymeric substrate containing pores;
a quantity of nanoparticles containing a selected catalyst in the pores of the plurality of electrodes; and
a solid polymer electrolyte that is porous covering the plurality of electrodes.

14. A methane sensor as claimed in claim 13, wherein the polymeric substrate is selected from the group consisting of Kapton®, polyfurfural alcohol, phenol-formaldehyde, lignin, cellulose, and graphene oxide.

15. A methane sensor as claimed in claim 13, wherein the plurality of electrodes are interdigitated with one another.

16. A methane sensor as claimed in claim 13, wherein the solid polymer electrolyte includes:
an ionic liquid dissolved in one of N-Methyl-2-pyrrolidone and dimethylformamide combined with polyvinylidene fluoride, or an ionic liquid dissolved in a solvent selected from the group consisting of:
polymethylmethacrylate, polyethylene oxide, polyvinyl chloride and polyethylene glycol combined with Nafion.

17. A methane sensor as claimed in claim 16, wherein the ionic liquid includes a component selected from the group consisting of 1-ethyl-3-methylimidazolium tetrafluoroborate, 1-ethyl-3-methylimidazolium bis(trifluoromethylsulfonyl)imide, and another bis(trifluoromethylsulfonyl)imide.

18. A methane sensor as claimed in claim 13, wherein the selected catalyst is selected from the group consisting of palladium, platinum, rhodium, iridium, or a combination of cobalt, nickel, phosphorous, a carbon nitride and a metal chalcogenide.

19. A methane sensor as claimed in claim 13, further comprising a membrane on an outside surface of the solid polymer electrolyte, wherein the membrane permits methane to pass therethrough but inhibits organic molecules that are larger than methane to pass therethrough.
